(19) United States
(12) Patent Application Publication
(10) Pub. No.: US 2010/0169788 A1
(43) Pub. Date: Jul. 1, 2010

(54) COMPUTER SYSTEM AND METHOD FOR COLLABORATIVE DATA VISUALIZATION, MANIPULATION AND ANALYSIS

(75) Inventors: Guljit KHURANA, McLean, VA (US); Calvin Henderson, McLean, VA (US)

Correspondence Address: MORRISON & FOERSTER LLP, 1650 TYSONS BOULEVARD, SUITE 400, MCLEAN, VA, 22102, US

(73) Assignee: Centrifuge Systems, Inc., McLean, VA (US)

(21) Appl. No.: 12/347,797

(22) Filed: Dec. 31, 2008

(51) Int. Cl. G06F 17/30; G06F 3/048

(52) U.S. Cl. 715/738; 707/E17.01; 707/E17.005

(57) ABSTRACT

A computer assisted system and method for the visualization, manipulation and analysis of data, in which a computer-assisted data visualization and analysis session undertaken by an analyst, including all intermediate and final data visualization, manipulation and analysis steps and functions, are electronically archived on a computer-readable medium and instantly made available to authorized collaborators so that authorized collaborators may review all the intermediate visualization, manipulation and analysis stages. Any authorized collaborator may choose any intermediate or final data visualization stage and commence a new, but related data visualization, manipulation and analysis derivative session. All derivative sessions, including all intermediate and final data visualization, manipulation and analysis steps and functions are archived and published to authorized collaborators.

### FIELD OF THE INVENTION

The present invention relates to computer-assisted systems and methods for interactive data visualization and analysis. More particularly, the present invention relates to methods and systems for multiple individuals to collaborate on the visualization, manipulation and analysis of a complex multi-dimensional data set.

### BACKGROUND OF THE INVENTION

Thorough analysis and comprehension of complex data sets is often the key to strategic decision making. While data presentation, visualization and manipulation software tools are known, they are limited in that they are one dimensional in terms of interactivity. That is, they are oriented towards a single user/single analytical process paradigm. For this reason, they do not contemplate and do not permit collaborative, integrated and interactive analysis of complex data sets among multiple users/analysts. This has effectively prevented organizations from effectively leveraging the collective intellect and knowledge of their work force on the same analytic problem. What is needed is an improved method for enabling collaboration in an interactive visual analysis context.

### SUMMARY OF THE INVENTION

In order to address the above-described short-comings in the prior art, the present invention provides methods and systems for multiple individuals to collaborate on the visualization, manipulation and analysis of a complex multi-dimensional data set. According to this invention, a computer assisted system and method for the visualization, manipulation and analysis of data is provided, in which a computer-assisted data visualization and analysis session undertaken by a user, analyst, or group of users/analysts, including all intermediate and final data visualization, manipulation and analysis steps and functions, are electronically maintained on a computer-readable medium and instantly made available to authorized collaborators so that authorized collaborators may review all the intermediate visualization, manipulation and analysis stages. In addition, any authorized collaborator may choose any intermediate or final data visualization stage and commence a new, but related data visualization, manipulation and analysis derivative session. Like the original session, all derivative sessions, including all intermediate and final data visualization, manipulation and analysis steps and functions are electronically stored and made available to authorized collaborators.

According to the invention, the data in any visualization, manipulation and analysis session may be displayed using multiple visualization techniques including quantitative, relational, temporal and geospatial views of the data. These visualizations are highly interactive, allowing a user to interrogate and ask questions through direct interaction with the display entities that are rendered. All user interactions with the system are saved as part of a session, and available for retrieval and additional review and analysis by the same user or by any authorized collaborator.

In this way, multiple analysts can collaborate in the visualization, manipulation and analysis of complex data sets, instantly sharing their conclusions and the data analysis sessions which led them to such conclusions. Collaborators can instantly access any intermediate stage in a visualization, manipulation and analysis session and follow the subsequent visualization, manipulation and analysis stages followed by the original session analyst, or, beginning from any first, intermediate or final visualization stage in the original session, start a new, derivative session to follow their own analytical processes and queries. Like the original session, each derivative session is made instantly available to each authorized collaborators, for review and/or the development of further derivative sessions.

The method allows for collaborators to see the effects of other collaborators, on the session, immediately. For example, if the author were to add an additional state while continuing the analysis, that artifact would be instantly available to the other collaborators. Finally, authorized collaborators are able to tag and annotate any stage of the session for subsequent review by the session author and/or other collaborators. In addition, any authorized collaborator may contribute to a current session at the discretion of the session author through simultaneous interactions with the data visualization.

The present invention provides for collaborative analysis in a visual paradigm in which users can simultaneously pursue a cognitive line of reasoning while visually exploring a complex set of data and in which the conclusions and insights can be shared amongst a group and leveraged immediately.

The present invention also provides a unique method for training analysts in the process of conducting effective visual analysis. Through the “unwinding” or replay of an electronically stored data visualization, manipulation and analysis session, new users can benefit from understanding the thought process behind an investigative approach pursued by seasoned analysts.

Accordingly, there is provided according to an embodiment of the invention a system for collaborative data visualization including a server and a database configured to store consecutive states of a computer-assisted data visualization session carried out by a first user; a server and a database configured to control access by a second user to said stored consecutive states of a computer-assisted data visualization session; a server and a database configured to allow said second user to select and display on a computer screen one or more of said stored consecutive states; a server and a database configured to consecutively display consecutive states said computer assisted data visualization session to said second user; a server and database configured to process new data visualization queries by said second user based on a stored state of said computer-assisted data visualization session; a server and a database configured to display new data visualization states based on said new data visualization queries by said second user; a server and a database configured to electronically store said new data visualization states as a derivative data visualization session.

There is also provided according to an embodiment of the invention a system for collaborative data visualization having a server and a database configured to store new consecutive states of said computer assisted data visualization session as they are generated by said first user and simultaneously make them available for display to said second user.

The servers described herein may be integrated into a single device or they may be separated into two or more devices. Similarly, the databases described herein may be integrated into a single database and/or with one or more of the servers described herein, or they may be maintained on separate devices.

There is also provided according to an embodiment of the invention a system for collaborative data visualization having a server and a database configured to receive and electronically store annotation input from said second user relating to one or more of said consecutive states of the first user's data visualization session.

There is also provided according to an embodiment of the invention a system for collaborative data visualization having a server and a database configured to make available for display to said first user said annotation input from said second user.

There is also provided according to an embodiment of the invention a system for collaborative data visualization having a server and a database configured to control access by a third user to said stored data visualization states of said derivative data visualization session; a server and a database configured to allow said third user to select and display on a computer screen one or more of said states of said derivative data visualization session; a server and a database configured to consecutively display consecutive states said derivative data visualization session to said third user; a server and database configured to process new data visualization queries by said third user based on a stored state of said derivative data visualization session; a server and a database configured to display new data visualization states based on said new data visualization queries by said third user; a server and a database configured to electronically store said new data visualization states as a sub-derivative data visualization.

There is also provided according to an embodiment of the invention a computer readable medium storing executable instructions to: store consecutive states of a computer-assisted data visualization session carried out by a first user; to control access by a second user to said stored consecutive states of a computer-assisted data visualization session; to allow said second user to select and display on a computer screen one or more of said stored consecutive states; to consecutively display consecutive states said computer assisted data visualization session to said second user; to process new data visualization queries by said second user based on a stored state of said computer-assisted data visualization session; to display new data visualization states based on said new data visualization queries by said second user; and to electronically store said new data visualization states as a derivative data visualization.

There is also provided according to an embodiment of the invention a computer readable medium storing executable instructions to store new consecutive states of said computer assisted data visualization session as they are generated by said first user and simultaneously make them available for display to said second user.

There is also provided according to an embodiment of the invention a computer readable medium storing executable instructions to receive and electronically store annotation input from said second user relating to one or more of said consecutive states of the first user's data visualization session.

There is also provided according to an embodiment of the invention a computer readable medium storing executable instructions to make available for display to said first user said annotation input from said second user.

There is also provided according to an embodiment of the invention a computer readable medium storing executable instructions to control access by a third user to said stored data visualization states of said derivative data visualization session; to allow said third user to select and display on a computer screen one or more of said states of said derivative data visualization session; to consecutively display consecutive states said derivative data visualization session to said third user; to process new data visualization queries by said third user based on a stored state of said derivative data visualization session; to display new data visualization states based on said new data visualization queries by said third user; and to electronically store said new data visualization states as a sub-derivative data visualization.

There is also provided according to an embodiment of the invention a method for collaborative data visualization and analysis, including providing a server and a database configured to store consecutive states of a computer-assisted data visualization session carried out by a first user; a server and a database configured to control access by a second user to said stored consecutive states of a computer-assisted data visualization session; a server and a database configured to allow said second user to select and display on a computer screen one or more of said stored consecutive states; a server and a database configured to consecutively display consecutive states said computer assisted data visualization session to said second user; a server and database configured to process new data visualization queries by said second user based on a stored state of said computer-assisted data visualization session; a server and a database configured to display new data visualization states based on said new data visualization queries by said second user; a server and a database configured to electronically store said new data visualization states as a derivative data visualization.

There is also provided according to an embodiment of the invention a method for collaborative data visualization and analysis including providing a server and a database configured to store new consecutive states of said computer assisted data visualization session as they are generated by said first user and simultaneously make them available for display to said second user.

There is also provided according to an embodiment of the invention a method for collaborative data visualization and analysis including providing a server and a database configured to receive and electronically store annotation input from said second user relating to one or more of said consecutive states of the first user's data visualization session.

There is also provided according to an embodiment of the invention a method for collaborative data visualization and analysis including providing a server and a database configured to make available for display to said first user said annotation input from said second user.

There is also provided according to an embodiment of the invention a method for collaborative data visualization and analysis including providing a server and a database configured to control access by a third user to said stored data visualization states of said derivative data visualization session; a server and a database configured to allow said third user to select and display on a computer screen one or more of said states of said derivative data visualization session; a server and a database configured to consecutively display consecutive states said derivative data visualization session to said third user; a server and database configured to process new data visualization queries by said third user based on a stored state of said derivative data visualization session; a server and a database configured to display new data visualization states based on said new data visualization queries by said third user; a server and a database configured to electronically store said new data visualization states as a sub-derivative data visualization.

### BRIEF DESCRIPTION OF THE DRAWINGS

The accompanying drawings, which are incorporated herein and form a part of the specification, illustrate the present invention and, together with the description, further serve to explain the principles of the invention by describing a number of embodiments of the present invention.

FIG. 1 is a representation of three successive interim states of a data visualization and analysis session according to an embodiment of the invention.

FIG. 2 is a representation of an interactive data visualization and analysis session having several interim states according to an embodiment of the invention.

FIG. 3 is a representation of access by authorized collaborators to an interactive data visualization and analysis session at different interim states.

FIG. 4 is a representation of an original data visualization and analysis session, including interim states, together with multiple derivative and sub-derivative sessions generated by authorized collaborators accessing an interim state of the original session or of a derivative session.

FIG. 5 is a representation of a computer system according to an embodiment of a method and system of the invention.

### DETAILED DESCRIPTION OF THE INVENTION

Specific embodiments of the present invention are now described with reference to various figures. While specific embodiments are described, it should be understood that this is done for illustrative purposes only. A person skilled in the art will recognize that other configurations can be used without departing from the spirit and scope of the present invention.

While various embodiments of the present invention have been described above, it should be understood that they have been presented by way of example only, and not as limitation. It will be apparent to those skilled in the art that various changes in form and detail can be made therein without departing from the spirit and scope of the invention, and such embodiments are within the purview of the present invention. Thus, the scope of the present invention should not be limited by any of the above-described embodiments, but should be defined only in accordance with the following claims and their equivalents. All patents and publications discussed herein are incorporated by reference.

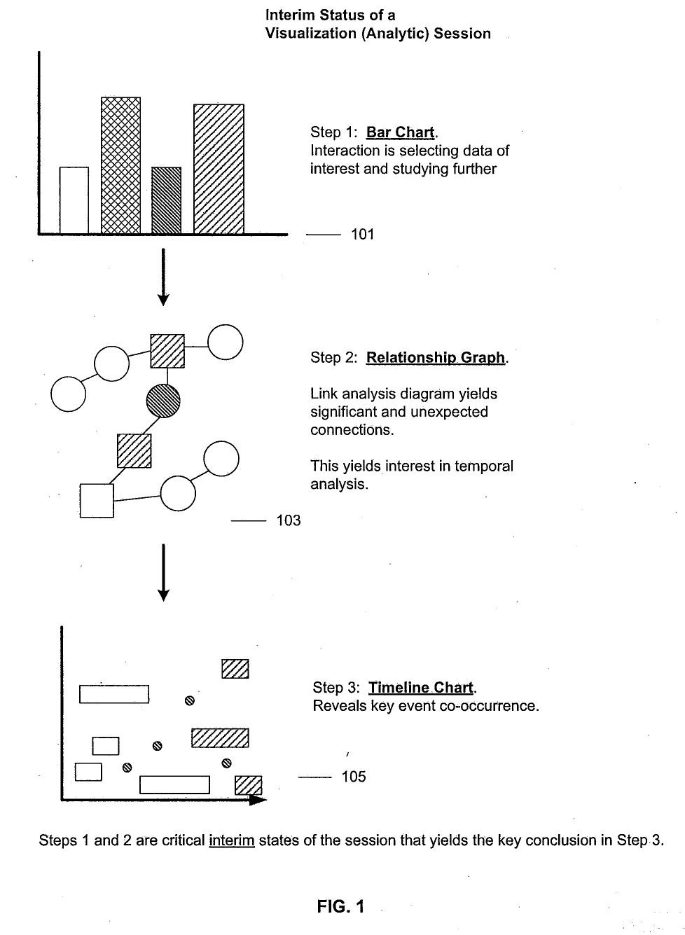

FIG. 1 is representation of three interim states 101, 103, 105, of an hypothetical interactive data visualization and analysis session that might be generated by an analyst using data visualization and manipulation software tools to assess a multi-dimensional set of data. For example, the data set might be the names, citizenship, country of origin, city of departure, city of arrival, date of departure, date of arrival, and airline, for all flights entering the U.S. during a given period of time. Depending on the purpose for which the analyst might be analyzing this data set, the analyst might request the tool to present a bar graph that shows the number of arrivals by country of origin. According to one embodiment of the invention, a session ID is generated and linked to the data set being analyzed and a user identification, and the first request for data visualization or interaction is electronically saved as stage 1 for that session ID. Having visualized the data according to a first visualization technique, resulting in a first session state 101, the analyst may then select a specific display element according to the first data presentation, and request then an operation be applied to indicate a particular line of reasoning. In the case of the example presented by FIG. 1, the user specified an interest in subsetting and dealing with the data underlying a particular data set, the data underlying a single bar in the bar graph, in isolation from the rest of the data. This selection and request may yield a link analysis diagram. Together, the selection, the request and the resultant link analysis diagram are electronically saved as interim state 103 for the session ID. The data visualization presented in state 103 is also highly interactive. From state 103, the analyst may select, for example, a temporal representation of a subset of the data underlying some portion of the stage 103 visualization. This selection might result in the time line representation shown at the bottom of FIG. 1. Together, this further selection, request and resultant time line visualization are electronically stored as state 105 for this session ID.

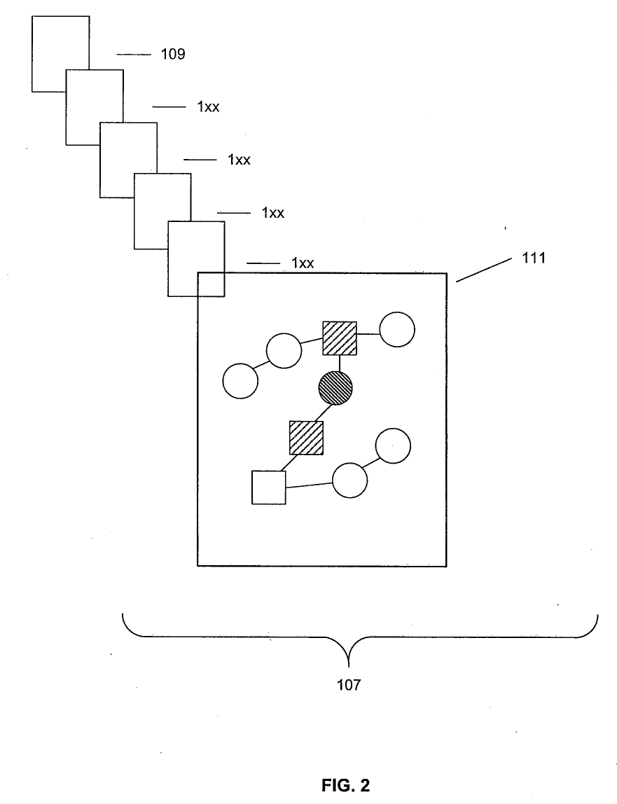

Through this process, any number of visualization stages may be produced and saved, together with the underlying data selection and processing request, as an analytic session. representing the beginning, interim and final states of an analytic session. FIG. 2 is a representation of a session 107, including beginning state 109, its current state 111 and all of its interim states 1xx. The current state 111 may ultimately become an interim state if the session is reopened.

According to the invention, when an analyst opens the data visualization and analysis tool to initiate a session, the system may give the analyst the option of starting a new session, or to select an existing session generated by the same analyst or a different analyst. If the analyst chooses to initiate a new session, the system may prompt the analyst to identify authorized collaborators who will be permitted to access and interact with the new session. Alternatively, the system may be set up so that authorizations are automatic, based on administrative and/or managerial protocol. If, instead of initiating a new session, the user selects an existing session, the system may allow access to the session if the analyst was the creator of the original session, or if the analyst is an authorized collaborator for a session generated by another analyst. If the analyst is refused access to an existing session, the system may be set up to send an access authorization request to the session creator or to an administrator.

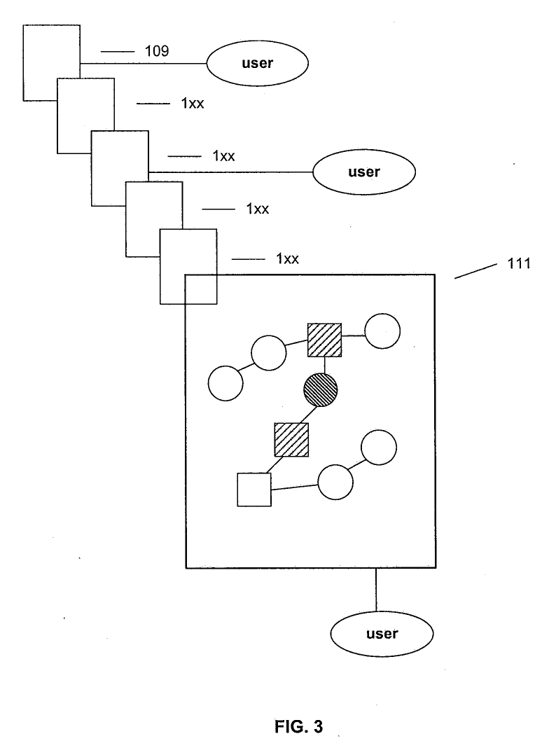

When an analyst is authorized to access an existing session, the existing session is presented to the authorized analyst, or “collaborator,” in such a way that the collaborator can view any of the beginning 109, interim 1xx and final 111 stages of the session 107, as shown in FIG. 3. According to one embodiment, all of the sessions for which a collaborator is authorized may be presented for selection of a particular session. According to a further embodiment, once a session has been selected, the entire session, or a portion thereof, may be presented to the collaborator as a series of thumbnails representing each of the states in the session from which the collaborator may select any state. From any starting point in the session, the collaborator may navigate forward and backward through the stages of the existing session. This allows collaborators to review not only final conclusions and insights, but the entire process through which the final state was reached. This allows users to unwind the analytic process and review the interim visualizations that were created as part of the initial analytic process.

Collaborators may also access an active session or a dormant session. As used herein, a dormant session is used to refer to a session that that is not currently in progress. As used herein, an active session is a data visualization, manipulation and analysis session that is currently in progress. In this case, each new stage is made available to the collaborators in real-time, or nearly real-time, as it is generated by the analyst that originated the session.

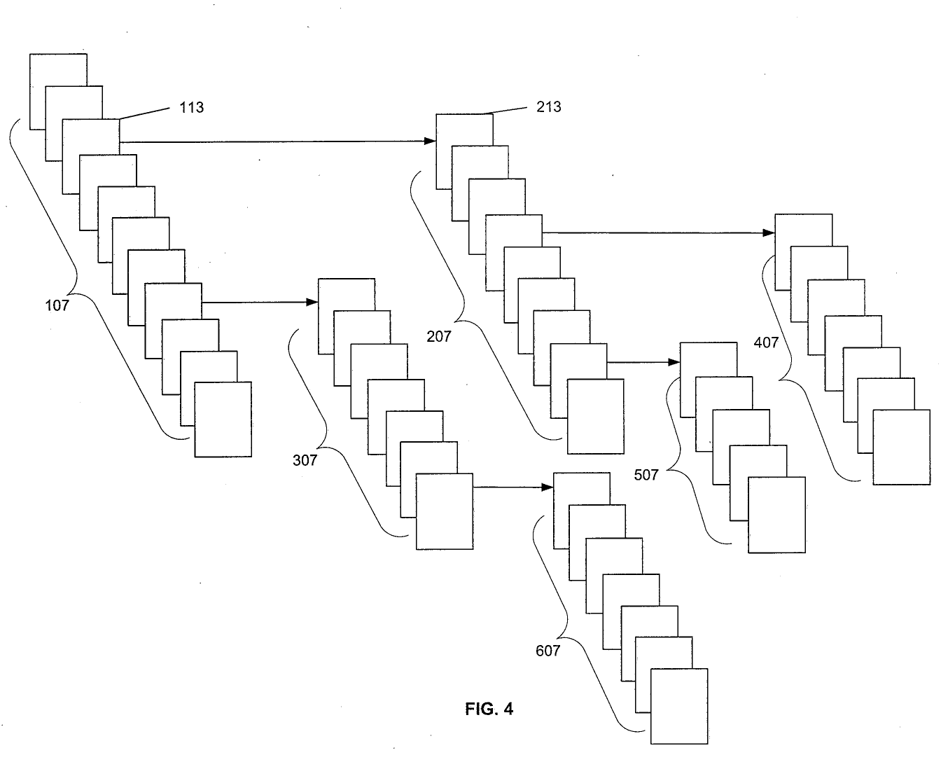

In addition to merely reviewing the various beginning, interim and final stages of dormant or active sessions, collaborators that have accessed an existing session may initiate derivative sessions. When a collaborator is viewing a session stage, the collaborator is presented with a menu that includes the option of interacting with the data according to his or her own queries. In this case, the collaborator may select various data selection, visualization and analytical tools that are different from the choices made during the original session. As shown in FIG. 4, a collaborator reviewing an original session 107 may select a particular session stage, for example stage 113, for further analysis. According to this embodiment, a first derivative stage 213 is created as a result of the collaborator interacting with the data presentation in stage 113 of an original session 107, and this derivative stage 213 is electronically stored as part of a derivative session 207. Subsequent collaborator interactions with the original session 107 will result in further derivative sessions, e.g., 307. In the same way that stages in original session 107 may be accessed to generate derivative sessions 207 and 307, subsequent collaborator interactions with stages in a derivative session, e.g., 207 or 307, may result in sub-derivative sessions, e.g., 407 and 607. Each derivative and sub-derivative sessions may include one or more intermediate derivative stages. Access to derivative sessions and sub-derivative sessions may be controlled in the same fashion as access to original sessions.

In this fashion, an original session and various derivative and sub-derivative sessions may be established, as shown in FIG. 4, all directed to a collaborative visualization and analysis of the same set of complex multi-dimensional data set, with all sessions, derivative and sub-derivative sessions available for review and further visualization and analysis by all collaborators.

According to a further embodiment of the invention, software is provided for implementing the method described herein. The following steps describe the process according to which an organization of users would carry out the method of this invention under the management of a computer program.

Step 1: A user initiates an interactive visualization session and designates that the session is to be shared with collaborators. Alternatively, authorized collaborators may be set by system default, or the system may be set up so that authorizations can be established or changed at any time.

Step 2: The user proceeds with the analysis through direct interaction with the data visualizations to uncover insights. This process will result in multiple artifacts or interim states that the user reaches through a particular line of inquiry. This process can include data subsetting and/or data augmenting, in which the use instructs the system to retrieve additional data that is related to the data undergoing analysis. For example, for a sample of data involving persons, the user can request the system to retrieve birth data information for each of the persons in sample being analyzed, if not already included in the present body of data.

Step 3: Other users, collaborators, access the session that was initiated by the first user. This access allows the collaborator(s) to move to the current state of the session or any of the interim states that were reached by the original analyst. From any state, the collaborator is able to contribute to the analysis through direct interaction with the visualizations.

Step 4: From any state, collaborators may also tag and annotate the artifacts. Any such ancillary information is instantly available to other collaborators.

Step 5: Collaborators and observers are able to see the analytic session unfold in real time. That is, any updates are instantly available to the other parties as they occur.

Another embodiment of this invention is the ability for collaborators to passively watch an analytic session in progress. This allows for users to observe the analysis without actually attaching to the session and contributing to it. The users would simply observer the session as a series of visualization states as the analysis is performed by the primary investigator.

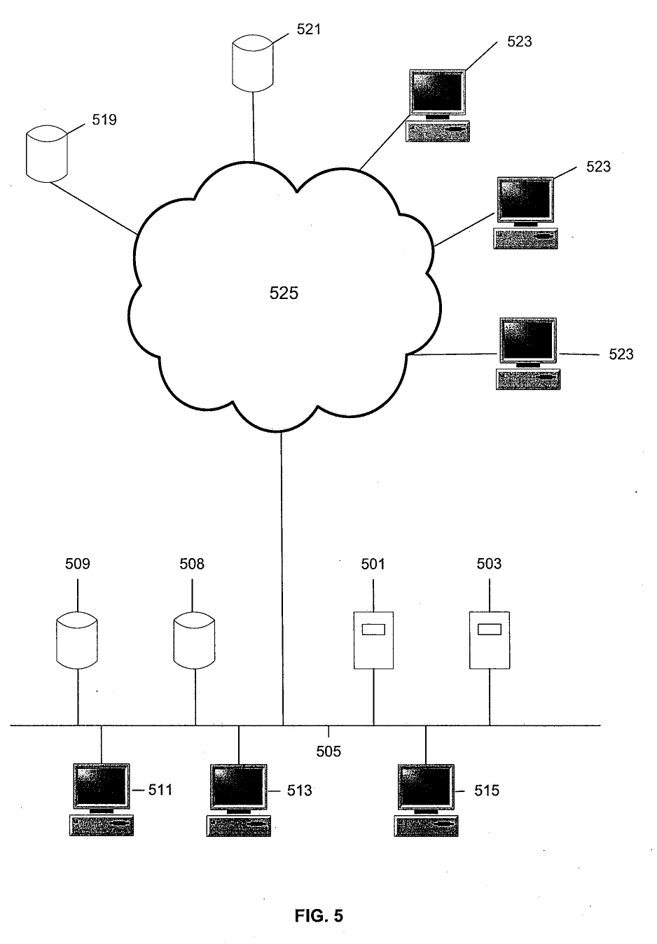

FIG. 5 is a representation of one embodiment of a system that could be used to implement the collaborative data visualization, manipulation and analysis method of the invention. Users at any one or more of computers 511, 513, 515, and 523 may initiate a data visualization, manipulation and analysis session by accessing hosting server 501 over a distributed network 525 or over a local network via connection 505. Alternatively, the data visualization, manipulation and analysis software tool may reside on one or more of computers 511, 513, 515 and 523. Users may request visualization, manipulation and analysis of data saved on their respective computers, on databases 509, 508, 519, 521 or on combinations thereof. When an analysis session is opened, the collaborator access authorization function may be integrated with the analysis tool, or it may be provided as separate software module. If provided as a separate software module, the collaborator access authorization function may reside on the same device as the data visualization and analysis tool or on a different device, e.g., 503. Similarly, data visualization and analysis session collaboration management functions, hereinafter referred to as collaborator manager, including storage of session stages in one or more databases 508, 509, 519 and 521, control of access, replay, review of sessions, as well as derivative session initiation by authorized collaborators, may be integrated with the analysis tool, or it may be provided as separate software module. The collaborator manager may reside on the same device as the data visualization and analysis tool or on a different device, e.g., 503. Original, derivative and sub-derivative stages need not be saved in the same location, provided that the collaborator manager tool tracks the storage location of all analysis sessions and provides authorized access as requested.

What is claimed is:

1. A system for collaborative data visualization, comprising:
a server and a database configured to store consecutive states of a computer-assisted data visualization session carried out by a first user;
a server and a database configured to control access by a second user to said stored consecutive states of a computer-assisted data visualization session;
a server and a database configured to allow said second user to select and display on a computer screen one or more of said stored consecutive states;
a server and a database configured to consecutively display consecutive states said computer assisted data visualization session to said second user;
a server and database configured to process new data visualization queries by said second user based on a stored state of said computer-assisted data visualization session;
a server and a database configured to display new data visualization states based on said new data visualization queries by said second user;
a server and a database configured to electronically store said new data visualization states as a derivative data visualization session.

2. A system for collaborative data visualization according to claim 1 further comprising a server and a database configured to store new consecutive states of said computer assisted data visualization session as they are generated by said first user and simultaneously make them available for display to said second user.

3. A system for collaborative data visualization according to claim 1 further comprising a server and a database configured to receive and electronically store annotation input from said second user relating to one or more of said consecutive states.

4. A system for collaborative data visualization according to claim 3 further comprising a server and a database configured to make available for display to said first user said annotation input from said second user.

5. A system for collaborative data visualization according to claim 1 further comprising a server and a database configured to control access by a third user to said stored data visualization states of said derivative data visualization session;
a server and a database configured to allow said third user to select and display on a computer screen one or more of said states of said derivative data visualization session;
a server and a database configured to consecutively display consecutive states said derivative data visualization session to said third user;
a server and database configured to process new data visualization queries by said third user based on a stored state of said derivative data visualization session;
a server and a database configured to display new data visualization states based on said new data visualization queries by said third user;
a server and a database configured to electronically store said new data visualization states as a sub-derivative data visualization.

6. A computer readable medium storing executable instructions to:
store consecutive states of a computer-assisted data visualization session carried out by a first user;
control access by a second user to said stored consecutive states of a computer-assisted data visualization session;
allow said second user to select and display on a computer screen one or more of said stored consecutive states;
consecutively display consecutive states said computer assisted data visualization session to said second user;
to process new data visualization queries by said second user based on a stored state of said computer-assisted data visualization session;
display new data visualization states based on said new data visualization queries by said second user;
electronically store said new data visualization states as a derivative data visualization.

7. A computer readable medium according to claim 4, further storing executable instructions to store new consecutive states of said computer assisted data visualization session as they are generated by said first user and simultaneously make them available for display to said second user.

8. A computer readable medium according to claim 4, further storing executable instructions to receive and electronically store annotation input from said second user relating to one or more of said consecutive states.

9. A computer readable medium according to claim 8, further storing executable instructions to make available for display to said first user said annotation input from said second user.

10. A computer readable medium according to claim 4, further storing executable instructions to:
control access by a third user to said stored data visualization states of said derivative data visualization session;
allow said third user to select and display on a computer screen one or more of said states of said derivative data visualization session;
consecutively display consecutive states said derivative data visualization session to said third user;
process new data visualization queries by said third user based on a stored state of said derivative data visualization session;
display new data visualization states based on said new data visualization queries by said third user;
electronically store said new data visualization states as a sub-derivative data visualization.

11. A method for collaborative data visualization and analysis, comprising providing:
a server and a database configured to store consecutive states of a computer-assisted data visualization session carried out by a first user;
a server and a database configured to control access by a second user to said stored consecutive states of a computer-assisted data visualization session;
a server and a database configured to allow said second user to select and display on a computer screen one or more of said stored consecutive states;
a server and a database configured to consecutively display consecutive states said computer assisted data visualization session to said second user;
a server and database configured to process new data visualization queries by said second user based on a stored state of said computer-assisted data visualization session;
a server and a database configured to display new data visualization states based on said new data visualization queries by said second user;
a server and a database configured to electronically store said new data visualization states as a derivative data visualization.

12. A method for collaborative data visualization and analysis according to claim 11, further comprising providing a server and a database configured to store new consecutive states of said computer assisted data visualization session as they are generated by said first user and simultaneously make them available for display to said second user.

13. A method for collaborative data visualization and analysis according to claim 11, further comprising providing a server and a database configured to receive and electronically store annotation input from said second user relating to one or more of said consecutive states.

14. A method for collaborative data visualization and analysis according to claim 13, further comprising providing a server and a database configured to make available for display to said first user said annotation input from said second user.

15. A method for collaborative data visualization and analysis according to claim 11, further comprising providing a server and a database configured to control access by a third user to said stored data visualization states of said derivative data visualization session;
a server and a database configured to allow said third user to select and display on a computer screen one or more of said states of said derivative data visualization session;
a server and a database configured to consecutively display consecutive states said derivative data visualization session to said third user;
a server and database configured to process new data visualization queries by said third user based on a stored state of said derivative data visualization session;
a server and a database configured to display new data visualization states based on said new data visualization queries by said third user;
a server and a database configured to electronically store said new data visualization states as a sub-derivative data visualization.
